(19) United States
(12) Patent Application Publication
(10) Pub. No.: US 2008/0083253 A1
(43) Pub. Date: Apr. 10, 2008

(54) DOOR LOCK ASSEMBLY WITH WHICH A DOOR CANNOT BE UNLATCHED BY ROTATING A HANDLE

(76) Inventors: Lan-Kun DON, Chiayi City (TW); Po-Yang CHEN, Chiayi City (TW); Ching-Chuan KUO, Chiayi County (TW)

Correspondence Address: LADAS & PARRY LLP, 224 SOUTH MICHIGAN AVENUE, SUITE 1600, CHICAGO, IL, 60604, US

(21) Appl. No.: 11/867,097

(22) Filed: Oct. 4, 2007

(30) Foreign Application Priority Data
Oct. 5, 2006 (TW) 095217954

(51) Int. Cl. E05B 55/00

(52) U.S. Cl. 70/472; 70/141

(57) ABSTRACT

A door lock assembly includes a sleeve connected to a handle, a spindle tube inserted into the sleeve and having a spindle tab to control a latch, and a spindle driving plate disposed transversely within the spindle tube. A tail piece of a key plug attached to the handle engages a central aperture of the spindle driving plate. A radial tooth of the spindle driving plate extends radially into a slot of the spindle tube so as to rotate the spindle tube when the spindle driving plate is rotated by the tail piece. The door lock assembly has no transmitting element to transmit rotational movement from the sleeve to the spindle tube and does not permit retraction of the latch by rotating the handle.

### CROSS-REFERENCE TO RELATED APPLICATION

This application claims priority of Taiwanese Utility Model Application No. 095217954 filed on Oct. 5, 2006.

### BACKGROUND OF THE INVENTION

1. Field of the Invention

This invention relates to a door lock assembly, more particularly, a door lock assembly with which a door cannot be unlatched by rotating a handle.

2. Description of the Related Art

There are door lock assemblies which are provided with inner and outer handles that can be rotated to operate a latch mechanism for latching or unlatching a door. The inner and outer handles are connected respectively to inner and outer sleeves. A rotary spindle inserted into the outer sleeve is connected to a latch actuator or retractor which in turn is connected to the latch mechanism. A press button rod is disposed within the inner sleeve and is connected to the rotary spindle. When a key plug disposed within the outer handle and connected to the rotary spindle is operated through a right key, the latch mechanism can be placed in a locking or unlocking state. When a press button disposed within the inner handle and connected to the press button rod is pressed, the latch mechanism is placed in a locking state. Therefore, such door lock assemblies have a key plug only in the outer handle, and are operated through a key at the outside of a door and through a press button at the inside of the door. Examples thereof are disclosed in U.S. Pat. Nos. 6,038,894, 6,615,630, 5,868,018, and 6,575,006.

### SUMMARY OF THE INVENTION

An object of the present invention is to provide a novel door lock assembly with which a door can be unlocked using only a key and in which handles are not permitted to retract a latch.

Another object of the present invention is to provide a novel door lock assembly useful for doors that require high security protection, for example, doors of warehouses, and the like.

Still another object of the present invention is to provide a novel door lock assembly which must be operated using a key either at the inside or the outside of a door.

According to this invention, a door lock assembly comprises: a handle; a sleeve connected to the handle; a latch unit adapted to latch a door; a latch-operator to operate the latch unit; a spindle tube inserted rotatably into the sleeve and having a spindle tab connected to the latch operator, and a slot extending radially through the spindle tube; a spindle driving plate disposed transversely within the spindle tube, and having a radial tooth, and a central aperture. The radial tooth extends radially into the slot for engaging and rotating the spindle tube when the spindle driving plate is rotated. The door lock assembly further comprises a lock disposed within the handle, and having a key plug, and a tail piece connected to the key plug. The tail piece extends axially into the spindle tube and the central aperture, and is engageable with the spindle driving plate within the central aperture so as to rotate the spindle driving plate. The door lock assembly has no transmitting element to transmit rotational movement from the sleeve to the spindle tube and the latch operator.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded view of a door lock assembly embodying the present invention;

FIG. 2 is a sectional view of a portion of the door lock assembly;

FIG. 3 is an exploded view showing a latching mechanism of the door lock assembly;

FIG. 4 is an exploded view showing the portion of the door lock assembly shown in FIG. 2;

FIG. 5 is a sectional view showing a sleeve, a spindle tube and a spindle driving plate of the door lock assembly;

FIG. 6 is the same view as FIG. 5 but showing that a tail piece engages the spindle driving plate; and

FIG. 7 is the same view as FIG. 5 but showing that the spindle driving plate starts to drive the spindle tube.

### DETAILED DESCRIPTION OF THE PREFERRED EMBODIMENT

Before the present invention is described in greater detail, it should be noted that same reference numerals have been used to denote like elements throughout the specification.

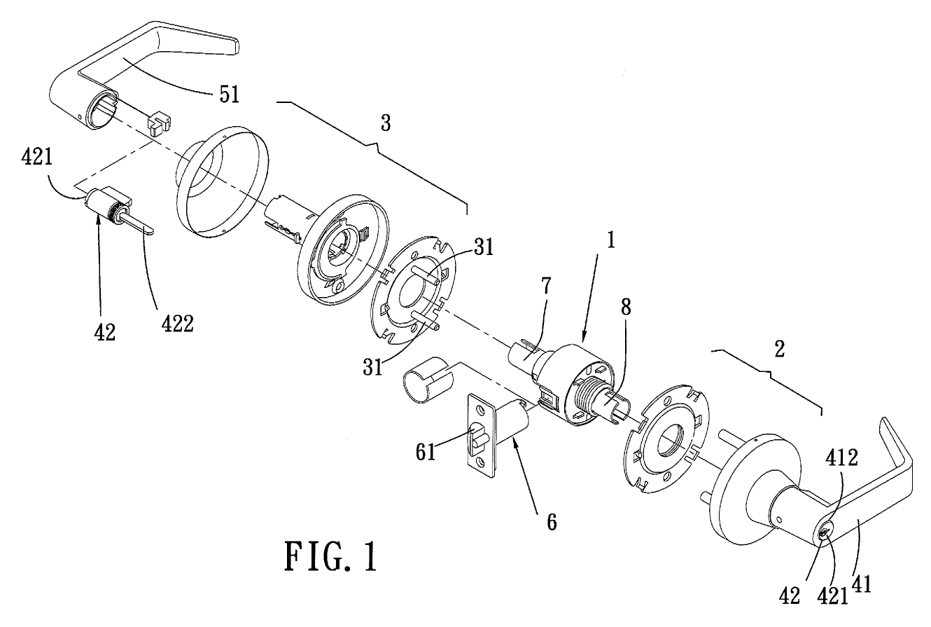

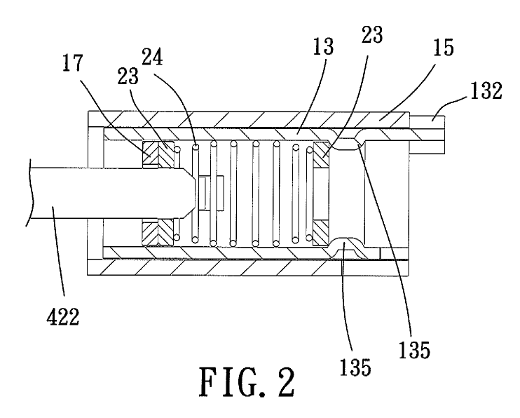

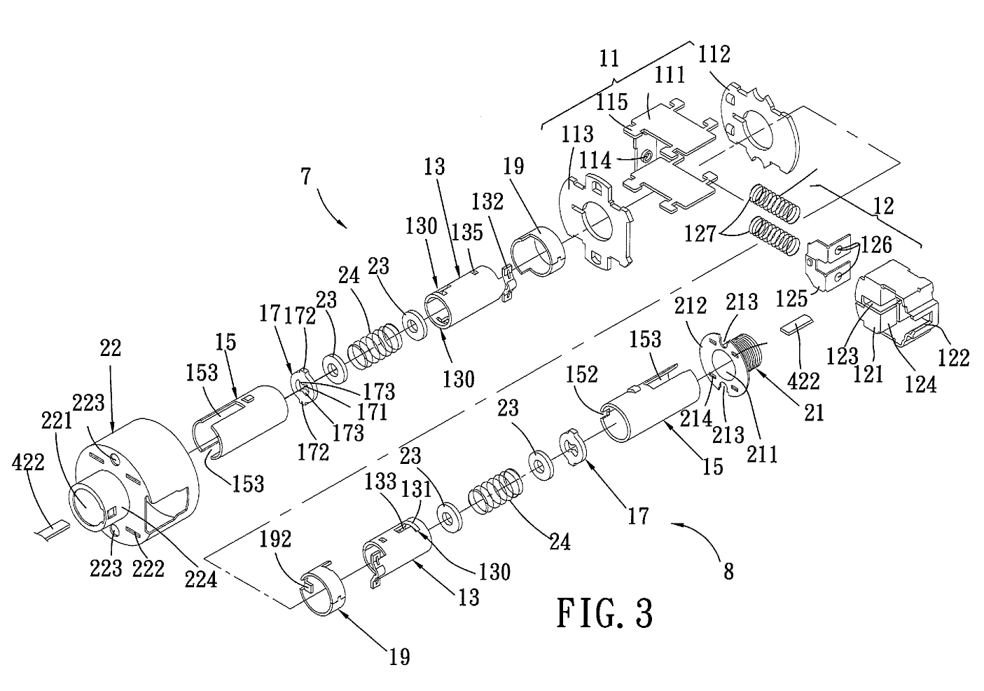

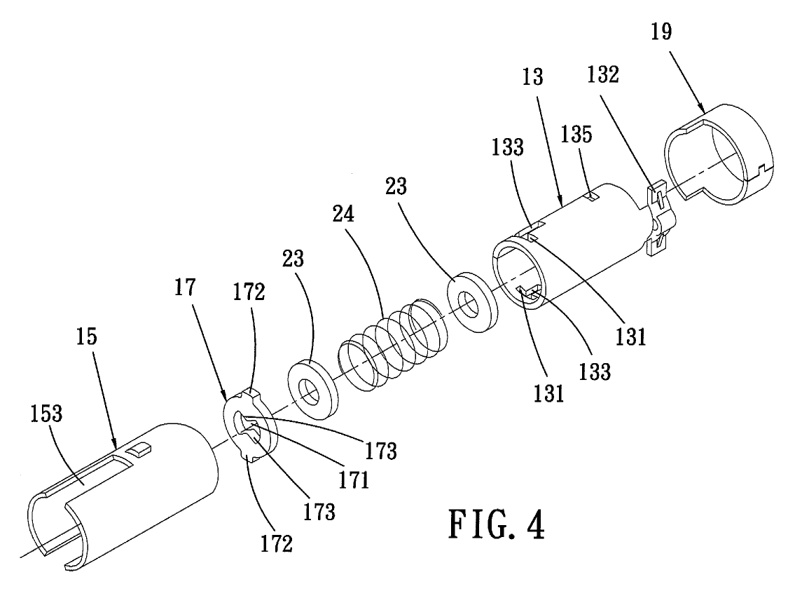

Referring to FIGS. 1 to 4, there is shown a door lock assembly embodying the present invention and including a latching mechanism 1 mountable on a door through inner and outer rose assemblies 2 and 3, inner and outer handles 41, 51 connected respectively to the inner and outer rose assemblies 2 and 3, a latch unit 6 to latch or unlatch the door, and inner and outer transmission units 8 and 7 connected to the latching mechanism 1.

Each of the inner and outer handles 41, 51 has a slot 412, and a lock set 42 mounted within the slot 421. The lock set 42 has a key plug 421 and a tail piece 422.

The latching mechanism 1 is known and includes a housing 22 carrying an operator case 11, a latch operator 12, and a bushing 21. The operator case 11 includes a base 111, and first and second cover plates 112, 113. The latch operator 12 is supported resiliently within the operator case 11.

The latch operator 12 includes an operator body 121 having an engaging part 122 to engage a latch 61 of the latch unit 6, a receiving part 123 opposite to the engaging part 122, a bearing part 124 disposed between the engaging part 122 and the receiving part 123, a retaining part 125 disposed within the receiving part 123 and having two retaining points 126, and two springs 127 having ends positioned to studs 114 and retaining points 126. Thus, the operator body 121 is biased by the springs 127 to move the latch 61 to a latching position.

Each of the inner and outer transmission unit 8, 7 includes a sleeve 15, a spindle tube 13, a spindle driving plate 17, and a ring 19.

The sleeve 15 of the inner or outer transmission unit 8, 7 has a notch 152, and two axial grooves 153. The sleeves 15 are connected to the inner and outer rose assemblies 2 and 3 in a known manner using the axial grooves 153. The sleeves 15 are also connected to the inner and outer handles 41, 51 in a known manner.

The spindle tube 13 is inserted rotatably into the sleeve 15, and has a spindle tab 132 to engage the bearing part 124 of the operator body 121, two diametrically opposite protrusions 135 projecting inwardly from the spindle tube 13 and disposed proximate to the spindle tab 132, and two diametrically opposite slots 130 extending radially through the spindle tube 13. Each slot 130 has a circumferential slot portion 131 that is elongated in a circumferential direction of the spindle tube 13, and an axial slot portion 133 elongated in an axial direction of the spindle tube 13 and adjoining the circumferential slot portion 131.

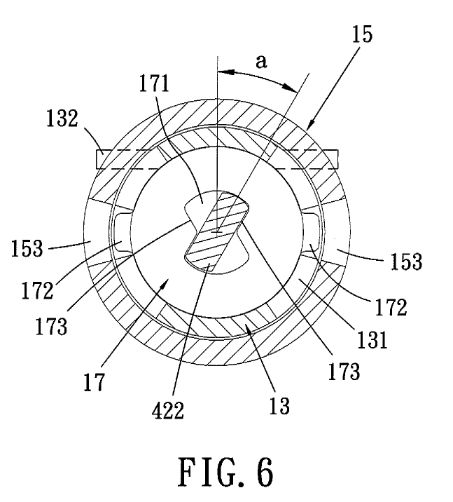

The spindle driving plate 17 is disposed transversely within the spindle tube 13, and has two diametrically opposite radial teeth 172 extending into the circumferential slot portions 131 for rotating the spindle tube 13 when the spindle driving plate 17 is rotated. As the circumferential slot portions 131 are elongated in the circumferential direction of the spindle tube 13, the radial teeth 172 are rotatable limitedly within the respective circumferential slot portions 131 and can engage the spindle tube 17 after being rotated by an angle (a) (see FIG. 6).

The axial slot portion 133 is provided in each slot 130 in order to facilitate assembly of the spindle driving plate 17 within the spindle tube 13. In assembly, an annular plate 23 is first placed transversely within the spindle tube 13 until the annular plate 23 is stopped by the protrusions 135 of the spindle tube 13. Thereafter, a coiled spring 24 is placed within the spindle tube 13 in abutment with the annular plate 23, and another annular plate 23 (or a second annular plate) is inserted into the spindle tube 13 to abut against the coiled spring 24. However, the second annular plate 23 is optional and may be dispensed with. After the coiled spring 24 is placed within the spindle tube 13, the spindle driving plate 17 is inserted and is pushed against the coiled spring 24 in such a manner that the spindle driving plate 17 is inclined with respect to an axis of the spindle tube 13 and the radial teeth 172 extend into the respective axial slot portions 133. When the pushing force exerted on the spindle driving plate 17 is released, the coiled spring 24 pushes the spindle driving plate 17 to move backward until the radial teeth 172 are moved into the circumferential slot portions 131 from the axial slot portions 133. In this state, the spindle driving plate 17 is perpendicular to the axis of the spindle tube 13. The coiled spring 24 is thus disposed between the two annular plates 23, and one of the annular plates 23 is disposed between the coiled spring 24 and the spindle driving plate 17. The protrusions 135 engage one side of the annular plate 23 opposite to the coiled spring 24.

The spindle driving plate 17 further has a central aperture 171 for passage of the tail piece 422 of the key plug 421. Preferably, the central aperture 171 is noncircular. The shape of the cross section of the central aperture 171 substantially resembles two sectors having truncated ends adjoining each other. The tail piece 422 is rotatable limitedly within the central aperture 171 and is engageable with one of engaging edges 173 of the central aperture 171 after being rotated by an angle.

The ring 19 is sleeved onto the sleeve 15 to increase the torsional strength of the sleeve 15, and has a finger 192 to engage the notch 152 of the sleeve 15.

The bushing 21 has a central hole 211 to receive the sleeve 15 of the inner transmission unit 8, a substantially annular flange 212, two diametrically opposite notches 213 formed in the annular flange 212 to engage hooks 115 provided in the base 111.

The housing 22 is substantially cylindrical, and has a constricted tubular portion 224 provided with a central bore 221, four engagement slots 222, and two passage slots 223. The operator case 11 is encased within the housing 22, and four of the hooks 115 of the base 111 engage the respective engagement slots 222. The sleeve 15 of the outer transmission unit 7 extends through the constricted tubular portion 224. The passage slots 223 permit support rods 31 (FIG. 1) of the outer rose assembly 3 to pass therethrough.

The main feature of the present invention resides in the inner and outer transmission units 8, 7 both of which have no transmitting element to transmit rotational movement from the sleeves 15 to the spindle tubes 13 and the latch operator 12. Although the spindle tubes 13 are inserted into the respective sleeves 15, the radial teeth 172 of the spindle tubes 13 do not extend into the axial grooves 153 of the respective sleeves 15. Furthermore, the finger 192 of each ring 19 also does not extend to the respective spindle tube 13.

Therefore, the latch 61 cannot be operated or retracted by rotating the inner and outer handles 41, 51. When the door lock assembly of the present invention is mounted on a door, the door can be unlatched using a key. The door cannot be unlatched by rotating the handles 41, 51.

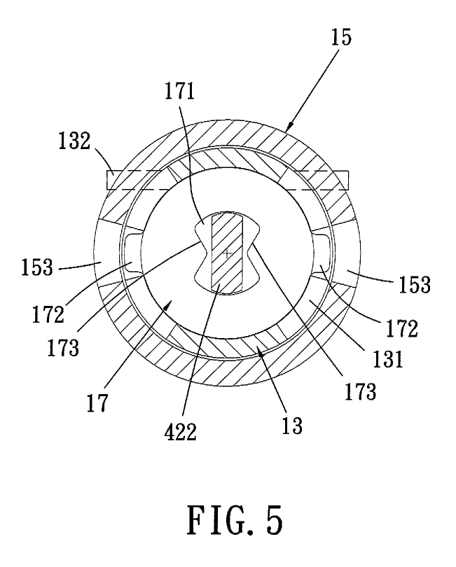

In use, the door lock assembly of the present invention is mounted on a door, and a key (not shown) must be used either at the inside or outside of the door to operate the door lock assembly so as to unlock the door. The operations of the tail piece 422, the spindle tube 13 and the spindle driving plate 17 during the rotation of the key plug 421 are demonstrated in FIGS. 5 to 7.

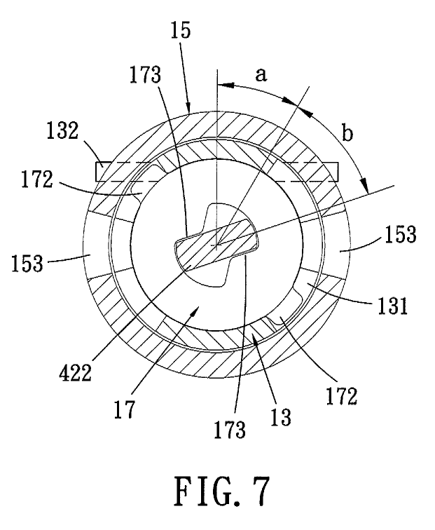

At the beginning, the tail piece 422 does not engage the spindle driving plate 17, and each radial tooth 172 is adjacent to one edge of the corresponding circumferential slot portion 131 of the spindle tube 13 as shown in FIG. 5. When the tail piece 422 within the central aperture 171 is rotated by an angle (a), the tail piece 422 engages one of the engaging edges 173 of the central aperture 171, as shown in FIG. 6, so that the spindle driving plate 17 can be rotated by the tail piece 422. However, the radial teeth 172 still cannot drive the spindle tube 13. When the tail piece 422 is rotated further by an angle (b), the spindle driving plate 17 is rotated and moves the radial teeth 172 to the opposite other edges of the circumferential slot portions 131 as shown in FIG. 7. At this stage, further rotation of the tail piece 422 can cause the spindle tube 13 to rotate. When the spindle tube 13 rotates, the spindle tab 132 will operate the latch 61 through the latch operator 12.

As described above, the tail piece 422 idles before engaging the engaging edge 173 of the central aperture 171 of the spindle driving plate 17, and the spindle driving plate 17 idles before engaging the edge of the circumferential slot portion 131. However, the present invention should not be limited thereto. The central aperture 171 and/or the slot 130 may be so shaped that no idling movement is produced by the tail piece 422 and/or the spindle driving plate 17.

While the present invention has been described in connection with what is considered the most practical and preferred embodiment, it is understood that this invention is not limited to the disclosed embodiment but is intended to cover various arrangements included with in the spirit and scope of the broadest interpretations and equivalent arrangements.

We claim:

1. A door lock assembly comprising:
a handle;
a sleeve connected to said handle;
a latch unit adapted to latch a door;
a latch operator to operate said latch unit;
a spindle tube inserted rotatably into said sleeve and having a spindle tab connected to said latch operator, and a slot extending radially through said spindle tube;
a spindle driving plate disposed transversely within said spindle tube, and having a radial tooth, and a central aperture, said radial tooth extending radially into said slot for engaging and rotating said spindle tube when said spindle driving plate is rotated; and
a lock disposed within said handle, and having a key plug, and a tail piece connected to said key plug, said tail piece extending axially into said spindle tube and said central aperture, and engageable with said spindle driving plate within said central aperture so as to rotate said spindle driving plate,
wherein the door lock assembly has no transmitting element to transmit rotational movement from said sleeve to said spindle tube and said latch operator.

2. The door lock assembly of claim 1, wherein said slot is elongated in a circumferential direction of said spindle tube, and said radial tooth is rotatable limitedly within said slot and is engageable with said spindle tube after being rotated by an angle within said slot.

3. The door lock assembly of claim 1, wherein said slot has a circumferential slot portion elongated in a circumferential direction of said spindle tube, and an axial slot portion elongated in an axial direction of said spindle tube and adjoining said circumferential slot portion.

4. The door lock assembly of claim 3, further comprising a coiled spring, and an annular plate disposed transversely within said spindle tube, said coiled spring being disposed between said annular plate and said spindle driving plate.

5. The door lock assembly of claim 4, wherein said spindle tube has a protrusion extending inwardly and radially to engage one side of said annular plate opposite to said coiled spring, said axial slot portion extending in a direction toward said protrusion from said circumferential slot portion.

6. A door lock assembly comprising:
a latch unit adapted to latch a door;
a latch operator to operate said latch unit;
inner and outer handles each of which has a lock disposed therein, said lock having a key plug, and a tail piece connected to said key plug;
inner and outer transmission units connected respectively to said inner and outer handles, each of said inner and outer transmission units including:
a sleeve connected to one of said inner and outer handles;
a spindle tube inserted rotatably into said sleeve and having a spindle tab connected to said latch operator, and a slot extending radially through said spindle tube; and
a spindle driving plate disposed transversely within said spindle tube, and having a radial tooth, and a central aperture, said radial tooth extending radially into said slot for engaging and rotating said spindle tube when said spindle driving plate is rotated;
said tail piece of each of said inner and outer handles extending axially into said spindle tube and said central aperture of a corresponding one of said inner and outer transmission units, and engageable with said spindle driving plate of a corresponding one of said inner and outer transmission units within said central aperture so as to rotate said spindle driving plate;
wherein the door lock assembly has no transmitting element to transmit rotational movement from said sleeve to said spindle tube in each of said inner and outer transmission units.
